(19) United States
(12) Patent Application Publication
(10) Pub. No.: US 2025/0097513 A1
(43) Pub. Date: Mar. 20, 2025

(54) METHOD FOR DISPLAYING OBJECT INFORMATION AND ELECTRONIC DEVICE

(71) Applicant: BEIJING DAJIA INTERNET INFORMATION TECHNOLOGY CO., LTD., Beijing (CN)

(72) Inventor: Yu LIN, Beijing (CN)

(21) Appl. No.: 18/591,582

(22) Filed: Feb. 29, 2024

(30) Foreign Application Priority Data
Sep. 15, 2023 (CN) 202311199478.7

(51) Int. Cl. H04N 21/431; G06Q 30/0601; H04N 21/2187; H04N 21/442; H04N 21/4725; H04N 21/478; H04N 21/8545

(52) U.S. Cl. CPC H04N 21/4316; G06Q 30/0631; G06Q 30/0633; H04N 21/2187; H04N 21/44213; H04N 21/4725; H04N 21/47815; H04N 21/8545

(57) ABSTRACT

Provided is a method for displaying object information. The method includes displaying, in response to an access operation on a target live-streaming room, a live-streaming interface of the target live-streaming room; and displaying a first object information display component and a second object information display component in the live-streaming interface. The component styles of the first object information display component and the second object information display component are different. The first object information display components is configured to display description information of a recommended object, the recommended object is an object currently recommended in the target live-streaming room, and the second object information display component is configured to display description information of an associated object.

### CROSS-REFERENCE TO RELATED APPLICATIONS

This application is based on and claims priority to Chinese Patent Application No. 202311199478.7, filed on Sep. 15, 2023, the disclosure of which is herein incorporated by reference in its entirety.

### TECHNICAL FIELD

The present disclosure relates to the field of Internet live-streaming technologies, and in particular to a method for displaying object information and an electronic device.

### BACKGROUND OF THE INVENTION

With rapid development of Internet live-streaming technologies, more users are presenting information of some objects, such as commodities, using live-streaming rooms provided by network live-streaming platforms.

### SUMMARY OF THE INVENTION

The present disclosure provides a method for displaying object information and an electronic device. The technical solutions of the present disclosure are as follows.

According to some embodiments of the present disclosure, a method for displaying object information is provided. The method includes:
displaying, in response to an access operation on a target live-streaming room, a live-streaming interface of the target live-streaming room; and
displaying at least two object information display components in the live-streaming interface, not all component styles of different object information display components being identical, wherein at least one of the object information display components is configured to display description information of a recommended object, the recommended object being an object currently recommended in the target live-streaming room, and at least one of the object information display components is configured to display description information of an associated object, the associated object being an object associated with the target live-streaming room.

According to some embodiments of the present disclosure, an apparatus for displaying object information is provided. The apparatus includes:
a response unit, configured to display, in response to an access operation on a target live-streaming room, a live-streaming interface of the target live-streaming room; and
a display unit, configured to display at least two object information display components in the live-streaming interface, not all component styles of different object information display components being identical, wherein at least one of the object information display components is configured to display description information of a recommended object, the recommended object being an object currently recommended in the target live-streaming room, and at least one of the object information display components is configured to display description information of an associated object, the associated object being an object associated with the target live-streaming room.

According to some embodiments of the present disclosure, an electronic device is provided. The electronic device includes a memory and a processor. The memory stores a computer program, and the processor, when executing the computer program, is caused to:
display, in response to an access operation on a target live-streaming room, a live-streaming interface of the target live-streaming room; and
display at least two object information display components in the live-streaming interface, not all component styles of different object information display components being identical, wherein at least one of the object information display components is configured to display description information of a recommended object, the recommended object being an object currently recommended in the target live-streaming room, and at least one of the object information display components is configured to display description information of an associated object, the associated object being an object associated with the target live-streaming room.

According to some embodiments of the present disclosure, a non-transitory computer-readable storage medium is provided. The storage medium stores a computer program. The computer program, when loaded and executed by a processor of an electronic device, cause the electronic device to:
display, in response to an access operation on a target live-streaming room, a live-streaming interface of the target live-streaming room; and
display at least two object information display components in the live-streaming interface, not all component styles of different object information display components being identical, wherein at least one of the object information display components is configured to display description information of a recommended object, the recommended object being an object currently recommended by the target live-streaming room, and at least one of the object information display components is configured to display description information of an associated object, the associated object being an object associated with the target live-streaming room.

According to some embodiments of the present disclosure, a computer program product is provided. The program product includes a computer program. The computer program is stored in a readable storage medium. At least one processor of a device, when loading and executing the computer program from the readable storage medium, cause the device to:
display, in response to an access operation on a target live-streaming room, a live-streaming interface of the target live-streaming room; and
display at least two object information display components in the live-streaming interface, not all component styles of different object information display components being identical, wherein at least one of the object information display components is configured to display description information of a recommended object, the recommended object being an object currently recommended in the target live-streaming room, and at least one of the object information display components is configured to display description information of an associated object, the associated object being an object associated with the target live-streaming room.

### BRIEF DESCRIPTION OF DRAWINGS

The accompanying drawings, which are incorporated in and form part of the description, illustrate the embodiments according to the present disclosure, serve to explain the principles of the present disclosure together with the description, and do not unduly limit the present disclosure.

FIG. 1 is an application environment diagram of a method for displaying object information according to some embodiments of the present disclosure;

FIG. 2 is a flowchart of a method for displaying object information according to some embodiments of the present disclosure;

FIG. 3 is a schematic diagram of a live-streaming interface according to some embodiments of the present disclosure;

FIG. 4 is a schematic diagram of another live-streaming interface according to some embodiments of the present disclosure;

FIG. 5 is a schematic diagram of still another live-streaming interface according to some embodiments of the present disclosure;

FIG. 6 a schematic diagram of still another live-streaming interface according to some embodiments of the present disclosure;

FIG. 7 is a flowchart of another method for displaying object information according to some embodiments of the present disclosure;

FIG. 8 is a block diagram of an apparatus for displaying object information according to some embodiments of the present disclosure; and

FIG. 9 is a block diagram of an electronic device according to some embodiments of the present disclosure.

### DETAILED DESCRIPTION

It should be noted that user information (including but not limited to user equipment information, user personal information, etc.) and data (including but not limited to data for display, data for analysis, etc.) involved in the present disclosure are all information and data authorized by users or fully authorized by all parties, and the collection, use and processing of relevant data need to comply with relevant laws, regulations and standards of relevant countries and regions.

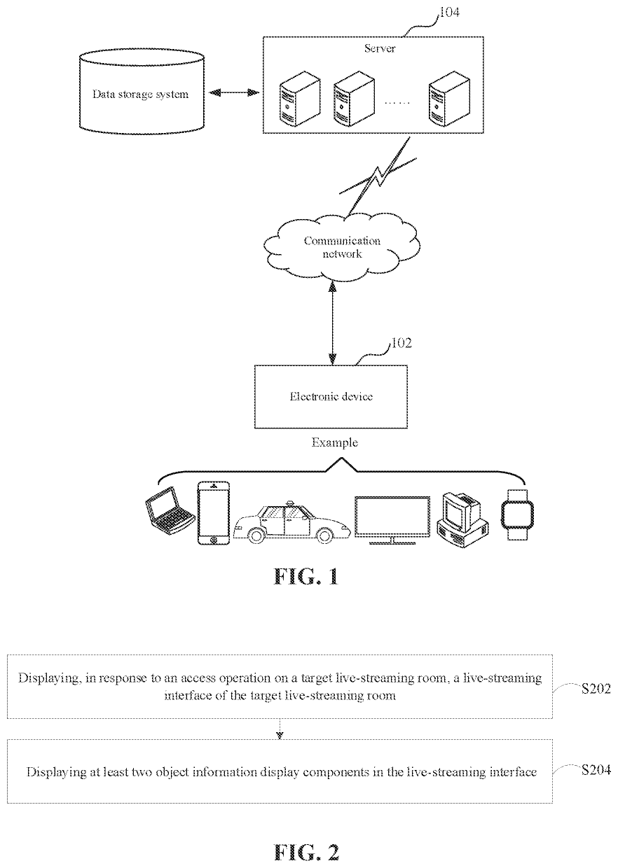

The method for displaying object information according to the present disclosure is applied to the application environment as shown in FIG. 1. An electronic device 102 communicates with servers 104 through a network. A data storage system stores the data needed to be processed by the servers 104. The data storage system is integrated on the servers 104 or placed on a cloud or other network servers. The electronic device 102 receives a live-streaming audio and video stream from the server 104 in response to an access operation on a target live-streaming room. The electronic device 102 displays a live-streaming interface of the target live-streaming room based on the live-streaming audio and video stream. The live-streaming audio and video stream are provided by an electronic device (not shown) on which an anchor is logged in. In some embodiments, the electronic device 102 displays at least two object information display components in the live-streaming interface. Not all the component styles of different object information display components are identical, at least one object information display component is configured to display description information of an object being currently recommended by the target live-streaming room, and at least one object information display component is configured to display description information of an object associated with the target live-streaming room. The electronic device 102 may be, but not limited to, various personal computers, notebook computers, smart phones, tablet computers, Internet of Things devices and portable wearable devices. The Internet of Things devices may be smart speakers, smart TVs, smart air conditioners, smart vehicle-mounted devices and the like. The portable wearable devices may be smart watches, smart bracelets, headsets and the like. The server 104 can be realized by an independent server or a server cluster composed of a plurality of servers. In practical application, the server 104 may also refer to a live-streaming platform.

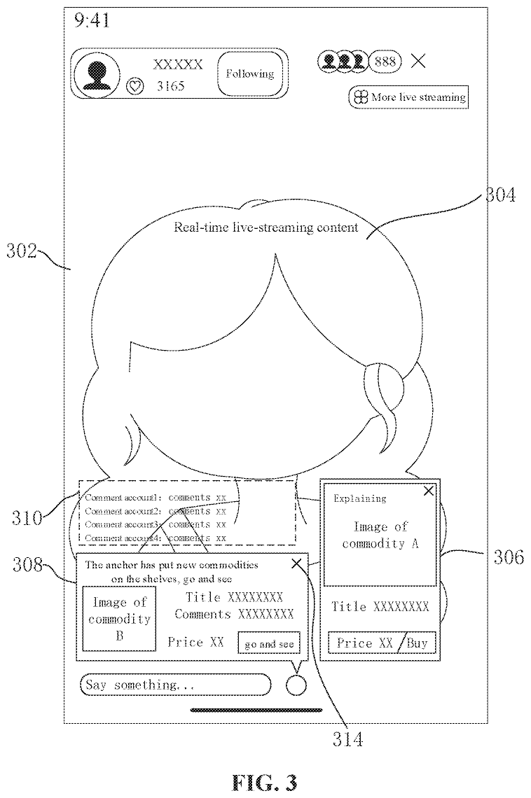

FIG. 2 is a flowchart of a method for displaying object information according to some embodiments. As shown in FIG. 2, the method for displaying object information is applied in the electronic device 102 of FIG. 1 and the electronic device is a device on which an audience user is logged in. The method includes the following processes.

In S202, in response to an access operation on a target live-streaming room, a live-streaming interface of the target live-streaming room is displayed.

In the embodiments of the present disclosure, live-streaming indicates that audience users watch media in real time on different live-streaming platforms through the network, and media content of the media is generated or uploaded by an anchor in real time. The audience users can communicate with the anchor in real time by sending bullet comments, comments and other messages, which is a new way of social networking.

In the embodiments of the present disclosure, the live-streaming room refers to a virtual space providing the above live-streaming service. The target live-streaming room refers to the live-streaming room chosen to be entered by a certain audience user. In some practical applications, the target live-streaming room is a live-streaming room recommending certain objects. For example, the anchor creating the target live-streaming room recommends the objects to the audience user entering the target live-streaming room by explaining the certain objects in the target live-streaming room. The objects refer to things existing objectively and distinguishable from each other, and the objects are physical objects or virtual objects. Taking a commodity recommendation live-streaming room as an example of the target live-streaming room, the objects refer to certain specific commodities, certain electronic commodities, certain virtual objects, or certain virtual services, which is not limited in the embodiments of the present disclosure.

In the embodiments of the present disclosure, the live-streaming interface refers to a front-end interface displaying live-streaming content of the target live-streaming room.

In the embodiments of the present disclosure, in the case that a certain audience user needs to acquire the live-streaming content of the target live-streaming room, the audience user inputs the access operation on the target live-streaming room to the electronic device by clicking an entry of the target live-streaming room in a front-end page or accessing a live-streaming room link of the target live-streaming room, etc. In response to the access operation on the target live-streaming room, the electronic device sends a pull-streaming request for the target live-streaming room to the live-streaming platform providing the live-streaming service of the target live-streaming room, so as to instruct the live-streaming platform to send the live-streaming audio and video stream of the target live-streaming room to the electronic device. The pull-streaming request is configured to pull the live-streaming audio and video stream. The live-streaming audio and video stream are generated by an anchor of the target live-streaming room. The electronic device displays the live-streaming interface of the target live-streaming room based on the live-streaming audio and video stream, and plays the real-time live-streaming content of the target live-streaming room through the live-streaming interface.

In S204, at least two object information display components are displayed in the live-streaming interface.

In the embodiments of the present disclosure, not all component styles of different object information display components are identical. In some embodiments, the component styles of the object information display components displaying the same type of information are the same, and the component styles of the object information display components displaying different types of information are different. In the above at least two object information display components, at least one object information display component is configured to display description information of a recommended object, and at least one object information display component is configured to display description information of an associated object. The recommended object is an object being currently recommended in the target live-streaming room, and the associated object is an object associated with the target live-streaming room.

In the embodiments of the present disclosure, the object information display component refers to a component displaying object information in the live-streaming interface. In some embodiments, the object information display component refers to a card component, a bubble component, a floating window component and the like in the live-streaming interface. The electronic device acquires the above object information display component and the description information displayed in the component from the live-streaming audio and video stream, and also acquires the above object information display component and the description information displayed in the component from a database corresponding to the target live-streaming room, which is not limited in the embodiments of the present disclosure.

In some embodiments, the object information display component includes a component closing entry. The user inputs a trigger operation on the component closing entry to the electronic device by clicking the component closing entry. In response to the trigger operation on the component closing entry, the electronic device stops displaying the object information display component selected to be closed by the user in the live-streaming interface, that is, cancels displaying the object information display component. The manner of cancelling the display includes removing the object information display component from the live-streaming interface or hiding the object information display component in the live-streaming interface.

In the embodiments of the present disclosure, the description information refers to the information for describing characteristics or attributes of the corresponding object. Taking the object being a commodity as an example, the description information of the commodity includes but are not limited to basic information of the commodity, basic decision-making information and core decision-making information. The basic information of the commodity includes basic cognitive information of the commodity, such as commodity picture, title and attribute label. The basic decision-making information and the core decision-making information are configured to help the users decide whether to purchase the commodity or not. The basic decision-making information includes trust information of the commodity, such as recommendation information and service guarantee information. The core decision-making information includes purchase decision-making information of the commodity, such as commodity price, inventory, price description and preferential label.

In some embodiments, in the process that the electronic device displays the live-streaming interface of the target live-streaming room and plays the real-time live-streaming content of the target live-streaming room through the live-streaming interface, the electronic device displays at least two object information display components of different component styles in the live-streaming interface.

In some embodiments, the electronic device displays the object information display component of a first style and the object information display component of a second style in the live-streaming interface. The electronic device displays the description information of the object being currently recommended by the target live-streaming room through the object information display component of the first style. The electronic device displays the description information of the object associated with the target live-streaming room through the object information display component of the second style.

In some embodiments, a method for displaying object information is provided. The method is performed by an electronic device on which an audience user is logged in, and includes: displaying, in response to an access operation on a target live-streaming room, a live-streaming interface of the target live-streaming room; and displaying a first object information display component and a second object information display component in the live-streaming interface. Component styles of the first object information display component and the second object information display component are different, and the component style comprises at least one of a component layout style, a component display size, or a component display position. The first object information display component is configured to display description information of a recommended object, the recommended object is an object currently recommended in the target live-streaming room, the second object information display component is configured to display description information of an associated object, and the associated object is an object associated with the target live-streaming room.

In some embodiments, the object associated with the target live-streaming room is an object that has been put on a shelves by an anchor of the live-streaming room. The information on the associated object may be determined by the anchor and constituted as one of live-streaming data provided by the anchor.

In order to facilitate the understanding of those skilled in the art, FIG. 3 exemplarily provides a schematic diagram of a live-streaming interface. As shown in FIG. 3, taking the target live-streaming room being the commodity recommendation live-streaming room as an example, the live-streaming interface 302 displays a real-time live-streaming content 304, i.e., a video of an anchor who is presenting commodities. In the process that the electronic device displays the real-time live-streaming content of the target live-streaming room through the live-streaming interface 302, the electronic device displays the first object information display component 306 of the first style in the live-streaming interface 302, i.e., the card component 306, and displays the second object information display component 308 of the second style in the live-streaming interface 302, i.e., the bubble component 308. The electronic device displays the commodity A being currently explained by the anchor of the target live-streaming room through the card component 306, and displays the commodity B through the bubble component 308 associated with the live-streaming room. In the illustrated example, the commodity B has been put on the shelves or has been released by the anchor of the target live-streaming room. The first object information display 306 further includes a component closing entry 312, and the second object information display 308 further includes a component closing entry 314.

In the related art, the live-streaming audio and video are typically played continuously with new content as the time goes on; and information on one object is typically displayed at a certain time period. Thus, the amount of information displayed is not diversified. In the method for displaying object information of the present disclosure, the at least two object information display components of different component styles are displayed in the live-streaming interface to display the description information of the object being currently recommended in the target live-streaming room and the description information of the object associated with the target live-streaming room. In the example that an object is a commodity recommended by an anchor and the object associated with the target live-streaming room is a commodity that has been put on shelves in the target live-streaming room, the information on the object previously presented in the target live-streaming room (the associated object) is displayed again along with the object currently recommended (e.g., an object being currently recommended). Further, the electronic device displays the object being currently recommended and the associated object associated in the live-streaming interface simultaneously, and displays in the separate and distinguishable display components. In this way, the richness and amount of information of the objects displayed in the live-streaming interface is improved and the efficiency of acquiring various object information by the users through the live-streaming interface is enhanced.

In some embodiments, displaying at least two object information display components of different component styles in the live-streaming interface includes: displaying the object information display component for the recommended object in the live-streaming interface, and displaying the object information display component for the associated object in the live-streaming interface. In order to express more clearly, displaying at least two object information display components of different component styles in the live-streaming interface includes: displaying at least one first display component in the live-streaming interface, the first display component being the object information display component for the recommended object; and displaying at least one second display component in the live-streaming interface, the second display component being the object information display component for the associated object. The first display component and the second display component have different component styles, and the component style includes at least one of a component layout style, a component display size or a component display position.

In some embodiments, the object information display component of the recommended object and the object information display component of the associated object have different component styles, wherein the component style includes at least one of the component layout styles, the component display size or the component display position.

The recommended object is an object being currently recommended by the target live-streaming room. Taking the target live-streaming room being the commodity recommendation live-streaming room as an example, the recommended object refers to a commodity being currently explained by the anchor of the target live-streaming room, and the recommended object is also called an object during explanation.

In some embodiments, the associated object is an object that has a specified association relationship with the target live-streaming room. For example, the associated object refers to an object preselected to be released, displayed and recommended in the target live-streaming room. Taking the target live-streaming room being the commodity recommendation live-streaming room as an example, the associated object refers to a commodity that has been put on the shelves or preset to be released in the target live-streaming room, and the recommended object is also called an object that has been put on the shelves.

In some embodiments, in the process that the electronic device displays at least two object information display components having different component styles in the live-streaming interface, the electronic device displays the object information display component for the recommended object and the object information display component for the associated object in the live-streaming interface. The electronic device has different component layout styles, component display sizes or component display positions to distinguish the object information display component for the recommended object and the object information display component for the associated object. In order to facilitate the understanding of those skilled in the art, referring to FIG. 3 again. As shown in FIG. 3, the card component 306 and the bubble component 308 in FIG. 3 have different component layout styles, component display sizes and component display positions, and the electronic device clearly displays the description information of the recommended object and the description information of the associated object separately using different component styles in the live-streaming interface.

In the technical solution of the present embodiment, the object information display component for the recommended object and the object information display component for the associated object are displayed in the live-streaming interface, and different component layout styles, component display sizes or component display positions can be adopted for the object information display component for the recommended object and the object information display component for the associated object, such that the description information of the recommended object and the description information of the associated object can be effectively distinguished and displayed in the live-streaming interface. As the description information of the objects can be effectively distinguished and classified, it is convenient for the audience users to quickly acquire the information that can meet the needs of information acquisition in the live-streaming interface.

In some embodiments, in response to a plurality of associated objects being present, displaying the object information display component of the associated objects in the live-streaming interface includes: acquiring a target object list by arranging and combining the associated objects according to preset arrangement and combination rules; and in the object information display component of the associated objects, displaying the description information of the associated objects in the target object list.

In some embodiments, in response to a plurality of associated objects being present, displaying at least one second display component in the live-streaming interface includes: acquiring a target object list by arranging and combining the plurality of associated objects according to preset arrangement and combination rules; and displaying the description information of the associated objects in the target object list in the second display component.

The preset arrangement and combination rules include but are not limited to attribute characteristics of the associated objects, matching degrees between the audience and the associated objects and the like.

In some embodiments, in response to a plurality of associated objects being present, in the process that the electronic device displays the object information display component of the associated objects in the live-streaming interface, the server acquires the target object list by arranging and combining the associated objects according to the preset arrangement and combination rules; and then the electronic device displays the description information of the associated objects in the target object list in the object information display component of the associated objects. Taking the target live-streaming room being the commodity recommendation live-streaming room as an example, the server can count the quantity of commodities on the shelves, and in the case that the server detects that a plurality of commodities that have been put on the shelves by the anchor, the server acquires a target commodity list by arranging and combining the commodities that have been put on the shelves based on the attribute characteristics (such as the information of price, sales volume, cost performance and the like). In another example, the server acquires the target commodity list by arranging and combining the commodities that have been put on the shelves based on the matching degrees between the audience and the commodities that have been put on the shelves. The matching degrees are acquired by processing characteristics of the audience and the characteristics of the commodities that have been put on the shelves through a pre-trained recommendation model.

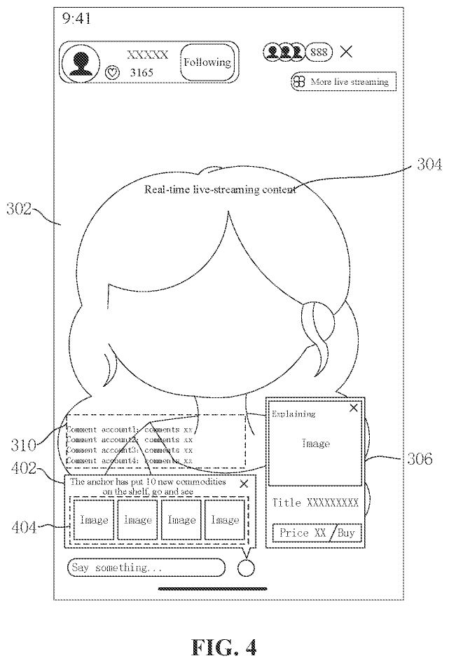

In order to facilitate the understanding of those skilled in the art, FIG. 4 exemplarily provides the schematic diagram of another live-streaming interface. As shown in FIG. 4, taking the target live-streaming room being the commodity recommendation live-streaming room as an example, the electronic device displays the object information display component of a third style in the live-streaming interface 302, i.e., another bubble component 402 in FIG. 4, a commodity list 404 acquired by arranging and combining the commodities that haven been put on the shelves according to the preset arrangement and combination rules is displayed through the another bubble component 402, and through the commodity list 404, image information of the commodities that have been put on the shelves is displayed.

In the technical solution of the present embodiment, the associated objects are arranged and combined according to the preset arrangement and combination rules to acquire the target object list, and the description information of the associated objects in the target object list is displayed in the object information display component of the associated objects, such that the description information of the objects associated with the target live-streaming room can be displayed in the live-streaming interface as much as possible, and the information richness and amount of information of the objects displayed in the live-streaming interface are effectively improved.

In some embodiments, the description information includes an object image, and in response to the quantity of objects in the target object list being greater than a preset quantity threshold, displaying the description information of the associated objects in the target object list includes: cyclically displaying a screen of the object images of the associated objects in the target object list by sliding sequentially from one side to the other side of the object information display component of the associated object.

In some embodiments, the description information includes an object image, and displaying the description information of the associated objects in the target object list in the second display component includes: in response to the quantity of objects of the plurality of associated objects in the target object list being greater than a preset quantity threshold, cyclically displaying a screen of the object images of the plurality of associated objects by sequentially sliding from one side to the other side of the second display component.

In some embodiments, due to a limited information display area of the object information display component, in the case that the electronic device detects that the quantity of objects in the target object list, that is, the quantity of objects of the plurality of associated objects, is greater than a preset quantity threshold, the electronic device cyclically displays the screen of the object images of the associated objects in the target object list by sequentially sliding from one side to the other side of the object information display component of the associated objects in the object information display component of the associated objects, i.e., in the second display component. In the example illustrated in FIG. 4, the quantity threshold is set to be 4.

For example, please refer to FIG. 4 again. In the case that the electronic device detects that the quantity of commodities which have been put on the shelves by the anchor is more than four, the electronic device displays the images of the commodities that have been put on the shelves by moving the images from the right side of to the left side of bubble component 402 such that the position for the fourth image is updated to show the remaining commodity in FIG. 4, so as to fully display the image information of the commodities in the list of commodities that have been put on the shelves.

In the technical solution of the present embodiments, in the case that the quantity of objects in the target object list is greater than the preset quantity threshold, the screens of the object images of the associated objects in the target object list are cyclically displayed in the object information display component of the associated objects, that is, sliding sequentially from one side to the other side of the object information display component of the associated objects, such that the object information display component of the associated objects can fully display the image information of the associated objects, which effectively improves the amount of information of the objects displayed in the live-streaming interface, and improves the efficiency of acquiring various object information by the users through the live-streaming interface.

In some embodiments, displaying the object information display component of the associated object in the live-streaming interface includes displaying the object information display component of the associated object in a target region in the live-streaming interface; wherein the target region is above or below a public comment display region of the live-streaming interface.

In some embodiments, displaying at least one second display component in the live-streaming interface includes: displaying at least one second display component in a target region in the live-streaming interface; wherein the target region is above or below a public comment display region of the live-streaming interface, and the public comment display region is configured to display comment information in the target live-streaming room.

In some embodiments, in the process that the electronic device displays the object information display component of the associated object in the live-streaming interface, the electronic device displays the object information display component for the associated object above or below the public comment display region of the live-streaming interface. In order to facilitate the understanding of those skilled in the art, referring to FIG. 3 again, the electronic device displays the bubble component 308 below the public comment display region 310 in the live-streaming interface.

In the technical solution of the present embodiments, in the process of displaying the object information display component of the associated object in the live-streaming interface, the object information display component for the associated object is displayed above or below the public comment display region of the live-streaming interface, such that the object information display component of the associated object can be prevented from blocking the real-time live-streaming content of the target live-streaming room, and the influence of the live-streaming interface on a display effect of the real-time live-streaming content can be avoided.

In some embodiments, displaying the object information display component of the associated object in the live-streaming interface includes displaying object viewing prompt information in the object information display component of the associated object; wherein the object viewing prompt information includes prompt information that the anchor of the target live-streaming room has input a release instruction for the associated object, and/or quantity information of the associated object.

In some embodiments, displaying at least one second display component in the live-streaming interface includes: displaying object viewing prompt information in the at least one second display component, wherein the object viewing prompt information is configured to prompt at least one associated object that has been released by the anchor of the target live-streaming room, and/or the quantity of the at least one associated object.

The associated object refers to the object released by the anchor of the target live-streaming room or the object that has been put on shelve. It should be noted that the term “object released by the anchor” and the term “object that has been put on the shelves” are used interchangeably in the present disclosure. In some embodiments, in the case that the anchor of the target live-streaming room inputs the release instruction for a certain object, the object is determined as the associated object. Taking the object being the commodity as an example, in the case that the anchor of the target live-streaming room releases or puts a certain commodity on the shelves, the commodity is a commodity that has been put on the shelves.

The object viewing prompt information refers to the information for prompting the user to view the object.

In some embodiments, referring to FIG. 3, in the process that the electronic device displays the object information display component of the associated object in the live-streaming interface, the electronic device displays the prompt information that the anchor has input the release instruction for the associated object in the object information display component of the associated object, such as the information that “the anchor has put new commodities on the shelves, go and see”. In some embodiments, referring to FIG. 4, the electronic device displays the quantity information of the associated object in the object information display component of the associated object, such as the copywriting information that “the anchor has put 10 new commodities on the shelves go and see”.

In the technical solution of the present embodiment, in the process of displaying the object information display component of the associated object in the live-streaming interface, the prompt information that the anchor of the target live-streaming room has input the release instruction for the associated object and/or the quantity information of the associated object are/is displayed in the object information display component of the associated object, such that the users can quickly know a series of information of the associated object based on the object information display component of the associated object, and thus choose whether to access a display page of the associated object or not.

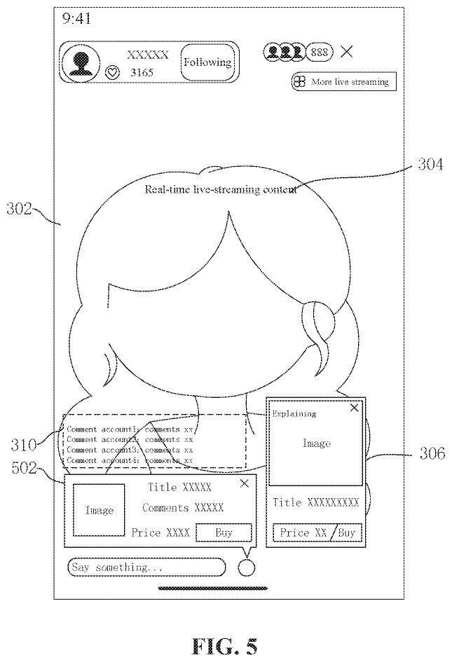

In some embodiments, the method further includes in response to a trigger operation, by the audience user, on the object information display component of the associated object, displaying a description information display page of the associated object in the live-streaming interface; and receiving an object interaction request initiated for the associated object through the description information display page. FIG. 5 exemplarily provides the schematic diagram of still another live-streaming interface. As shown in FIG. 5, in the case that the object information display component of the associated object is triggered, the description information display page of the associated object is displayed in the bubble component 502 in FIG. 5.

In some embodiments, the method further includes: in response to a trigger operation on any second display component, displaying a description information display page of at least one associated object displayed in the second component in the live-streaming interface, wherein the description information display page is configured to display the description information of the at least one associated object; and receiving an object interaction request initiated for the at least one associated object through the description information display page. In some embodiments, the second object information display component includes a control configured to, upon a trigger operation, cause a display of a description information display page of the associated object in the live-streaming interface. Referring to the example in FIG. 3, the control is a designated button, i.e., the “go and see” button. In another example, referring to FIG. 4, the image of the associated object may be configured as a control to trigger the display of a description information display page.

The description information display page refers to a page for displaying detailed information of the associated object. The detailed information includes price information of the associated object and the like. The object interaction request refers to a request indicating interaction with the associated object. Taking the commodity that has been put on the shelves as an example of the associated object, the object interaction request is a purchase request for the commodity that has been put on the shelves.

In some embodiments, after the users view the information displayed by the object information display component of the associated object, in the case that the users need to know more about the detailed information of the associated object to request interaction with the associated object, the users inputs the trigger operation on the object information display component of the associated object to the electronic device by clicking the object information display component of the associated object in the live-streaming interface. In response to the trigger operation on the object information display component of the associated object, the electronic device displays the description information display page of the associated object in the live-streaming interface. The electronic device receives the object interaction request initiated for the associated object through the description information display page.

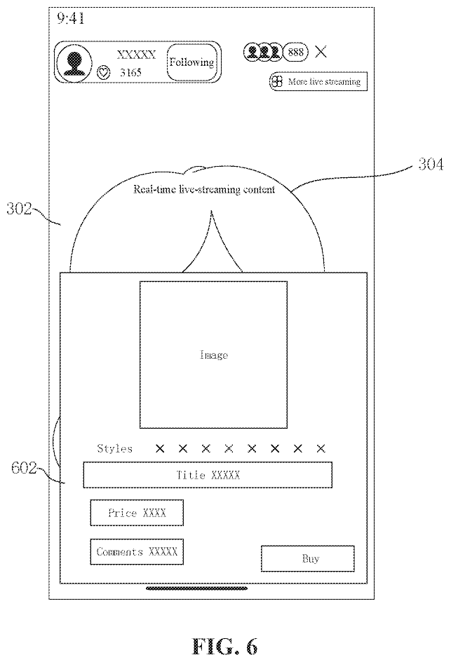

Taking the associated object being the commodity that has been put on the shelves as an example, in the case that the users click the object information display component of the commodity that has been put on the shelves, the electronic device displays a virtual shopping cart page or a virtual show-window page of the anchor in the live-streaming interface in a semi-screen mode. FIG. 6 exemplarily provides the schematic diagram of still another live-streaming interface. As shown in FIG. 6, the virtual show-window page is displayed in the bubble component 602 in a semi-screen mode. In this example, the description information display page is virtual shopping cart page or a virtual show-window page of the anchor. The electronic device also displays commodity price information, image information and the like of each commodity that has been put on the shelves through the virtual shopping cart page or the virtual show-window page. The users can input the purchase request for the commodity that has been put on the shelves through the virtual shopping cart page or the virtual show-window page.

In the technical solution of the present embodiments, in response to the trigger operation on the object information display component of the associated object, the description information display page of the associated object is displayed in the live-streaming interface, and the object interaction request initiated for the associated object is received through the description information display page, such that the users can further view the detailed information of the associated objects conveniently, and can quickly and accurately initiate the object interaction request for the associated objects.

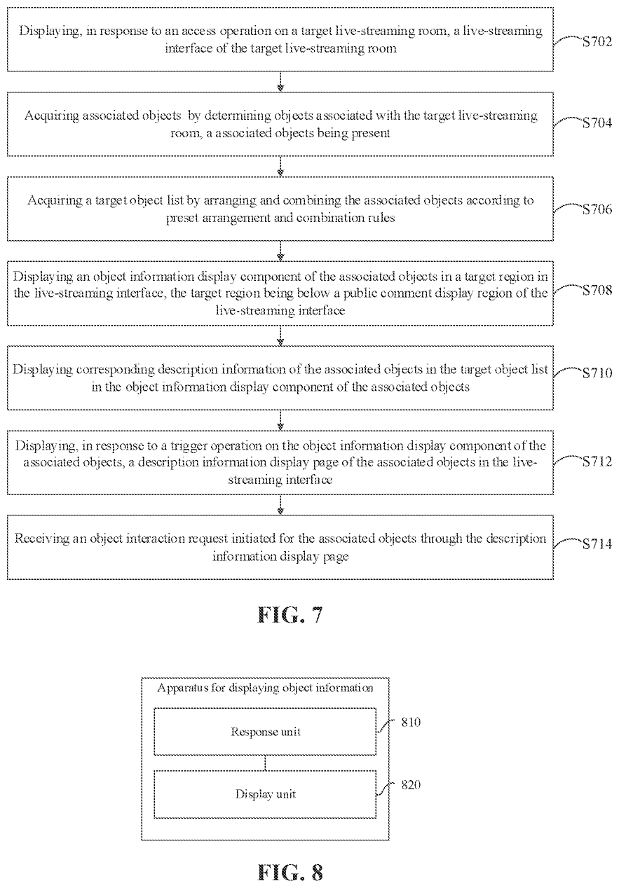

FIG. 7 is a flowchart of another method for displaying object information according to some embodiments. As shown in FIG. 7, the method is applicable to the electronic device in FIG. 1 and includes the following processes.

In S702, in response to an access operation on a target live-streaming room, a live-streaming interface of the target live-streaming room is displayed.

In S704, objects associated with the target live-streaming room are determined to acquire associated objects, and a plurality of associated objects are present.

In S706, a target object list is acquired by the arranging and combining the associated objects according to preset arrangement and combination rules.

In S708, an object information display component of the associated objects is displayed in a target region in the live-streaming interface; and the target region is below a public comment display region of the live-streaming interface.

In S710, description information of the associated objects in the target object list is displayed in the object information display component of the associated objects.

In S712, in response to a trigger operation on the object information display component of the associated objects, a description information display page of the associated objects is displayed in the live-streaming interface.

In S714, an object interaction request initiated for the associated objects is received through the description information display page.

It should be noted that the specific definition of the above processes can refer to the specific definition of the method for displaying object information above, and is not repeated here.

It should be understood that although the processes in the flowcharts of FIG. 2 and FIG. 7 are shown sequentially as indicated by arrows, these processes are not necessarily executed in order as indicated by the arrows. Unless explicitly stated herein, the execution of these processes is not strictly limited in order, and these processes are executed in other orders. Moreover, at least part of the processes in FIG. 2 and FIG. 7 include a plurality of steps or a plurality of stages, these steps or stages are not necessarily executed and completed simultaneously, but are executed at different times, and the execution order of these steps or stages are not necessarily sequentially executed, but are alternately or alternatively executed with other processes or at least part of the steps or stages in the other processes.

It can be understood that the same/similar parts between various embodiments of the above method in the description refer to each other, each embodiment focuses on the differences from the other embodiments, and the relevant parts refer to the illustrations of other method embodiments.

FIG. 8 is a block diagram of an apparatus for displaying object information according to some embodiments. Referring to FIG. 8, the apparatus includes:
a response unit 810, configured to display, in response to an access operation on a target live-streaming room, a live-streaming interface of the target live-streaming room; and
a display unit 820, configured to display at least two object information display components in the live-streaming interface, not all component styles of different object information display components being identical, wherein at least one object information display component is configured to display description information of a recommended object, the recommended object is an object being currently recommended in the target live-streaming room, at least one object information display component is configured to display description information of an associated object, and the associated object is an object associated with the target live-streaming room.

In some embodiments, the display unit 820 is configured to display at least one first display component in the live-streaming interface, the first display component being the object information display component for the recommended object; and display at least one second display component in the live-streaming interface, the second display component being the object information display component for the associated object; wherein the first display component and the second display component have component styles, and the component style includes at least one of a component layout style, a component display size or a component display position.

In some embodiments, in response to a plurality of associated objects being present, the display unit 820 is configured to acquire a target object list by arranging and combining the plurality of associated objects according to preset arrangement and combination rules; and display the description information of the associated objects in the target object list in the second display component.

In some embodiments, the description information includes an object image, and in response to the quantity of objects of the plurality of associated objects in the target object list being greater than a preset quantity threshold, the display unit 820 is configured to cyclically display a screen of the object images of the plurality of associated objects sequentially sliding from one side to the other side of the second display component in the second display component.

In some embodiments, the display unit 820 is configured to display the at least one second display component in a target region in the live-streaming interface; wherein the target region is above or below a public comment display region of the live-streaming interface, and the public comment display region is configured to display comment information in the target live-streaming room.

In some embodiments, the display unit 820 is configured to display object viewing prompt information in the at least one second display component, the object viewing prompt information being configured to prompt at least one associated object that has been released by an anchor of the target live-streaming room, and/or the quantity of the at least one associated object.

In some embodiments, the display unit 820 is further configured to display, in response to a trigger operation on any second display component, a description information display page of at least one associated object displayed in the second component in the live-streaming interface, the description information display page being configured to display the description information of the at least one associated object; and receive an object interaction request initiated for the at least one associated object through the description information display page.

Regarding the apparatus in the above embodiment, specific ways in which the modules execute operations have been described in detail in the related method embodiments, which are not described repeatedly herein.

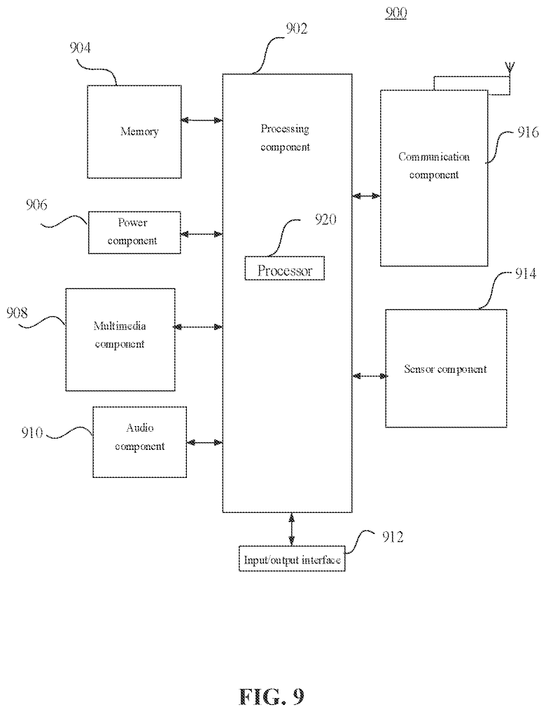

FIG. 9 is a block diagram of an electronic device 900 for executing the above method for displaying object information according to some embodiments. For example, the electronic device 900 may be a mobile phone, a computer, a digital broadcast terminal, a message transceiver device, a game console, a tablet device, a medical device, a fitness device, a personal digital assistant, and the like.

Referring to FIG. 9, the electronic device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the electronic device 900, such as the operations associated with display, telephone calls, data communications, camera operations, and recording operations. The processing component 902 includes one or more processors 920 to execute instructions to complete all or part of the processes in the above method. Moreover, the processing component 902 includes one or more modules which facilitate the interaction between the processing component 902 and other components. For instance, the processing component 902 includes a multimedia module to facilitate the interaction between the multimedia component 908 and the processing component 902.

The memory 904 is configured to store various types of data to support the operation of the electronic device 900. Examples of such data include instructions for any application programs or methods operated on the electronic device 900, contact data, phonebook data, messages, pictures, video, etc. The memory 904 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, an optical disk or a graphene memory.

The power component 906 supplies power to various components of the electronic device 900. The power component 906 includes a power management system, one or more power sources, and other components associated with the generation, management, and distribution of power of the electronic device 900.

The multimedia component 908 includes a screen providing an output interface between the electronic device 900 and the user. In some embodiments, the screen includes a liquid crystal display (LCD) and a touch panel (TP). In the case that the screen includes the touch panel, the screen can be implemented as a touch screen to receive input signals from the user. The touch panel includes one or more touch sensors to sense touches, slips, and gestures on the touch panel. The touch sensors not only sense a boundary of a touch or slip action, but also sense a period of time and a pressure associated with the touch or slip action. In some embodiments, the multimedia component 908 includes a front camera and/or a rear camera. The front camera and the rear camera receive external multimedia data when the electronic device 900 is in an operation mode, such as a photographing mode or a video mode. Each of the front camera and the rear camera may be a fixed optical lens system or have focal length and optical zoom capability.

The audio component 910 is configured to output and/or input audio signals. For example, the audio component 910 includes a microphone (MIC) configured to receive an external audio signal in the case that the electronic device 900 is in an operation mode, such as a call mode, a recording mode, and a voice recognition mode. The received audio signal is further stored in the memory 904 or transmitted via the communication component 916. In some embodiments, the audio component 910 further includes a speaker for outputting the audio signals.

The I/O interface 912 provides an interface between the processing component 902 and peripheral interface modules, such as a keyboard, a click wheel, buttons, and the like. The buttons may include, but are not limited to, a homepage button, a volume button, a starting button, and a locking button.

The sensor component 914 includes one or more sensors to provide status assessments of various aspects of the electronic device 900. For instance, the sensor component 914 detects an ON/OFF status of the electronic device 900 and relative positioning of the components, such as a display and a keypad, of the electronic device 900. The sensor component 914 also detects a change in position of the electronic device 900 or the components of the electronic device 900, a presence or absence of user contact with the electronic device 900, an orientation or an acceleration/deceleration of the device 900, and a change in temperature of the electronic device 900. The sensor component 914 includes a proximity sensor configured to detect the presence of nearby objects without any physical contact. The sensor component 914 further includes a light sensor, such as a CMOS or CCD image sensor, for use in imaging applications. In some embodiments, the sensor component 914 further includes an accelerometer sensor, a gyroscope sensor, a magnetic sensor, a pressure sensor, or a temperature sensor.

The communication component 916 is configured to facilitate wired or wireless communication between the electronic device 900 and other devices. The electronic device 900 may access a communication standard-based wireless network such as Wi-Fi, operator networks (such as 2G, 3G, 4G or 5G) or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module is implemented based on radio frequency identification (RFID), infrared data association (IrDA), ultra-wideband (UWB), Bluetooth (BT), and other technologies.

In an exemplary embodiment, the electronic device 900 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method.

In an exemplary embodiment, a computer-readable storage medium including instructions is provided, such as the memory 904 including one or more instructions. The processor 920 of the electronic device 900, when loading and executing the one or more instructions, is caused to perform the above method. For example, the computer-readable storage medium may be an ROM, a random access memory (RAM), a compact disc read-only memory (CD-ROM), a magnetic tape, a floppy disk, an optical data storage device, or the like.

In an exemplary embodiment, a computer program product is provided. The computer program product includes one or more instructions, and the processor 920 of the electronic device 900, when loading and executing the one or more instructions, is caused to perform the above method for displaying object information.

It should be noted that the above apparatus, electronic device, computer-readable storage medium, computer program product and the like further include other implementations according to the descriptions of the method embodiments, and the specific implementations refer to the descriptions of relevant method embodiments, and are not repeated in detail here.

Other embodiments of the present disclosure are readily conceivable for those skilled in the art from consideration of the description and practice of the present disclosure disclosed here. The present disclosure is intended to cover any transformations, uses, or adaptive changes of the present disclosure. These transformations, uses, or adaptive changes follow general principles of the present disclosure and include the common general knowledge or conventional technical means, not disclosed in the present disclosure, in the art. The description and the embodiments are considered as exemplary only, with a true scope and spirit of the present disclosure being indicated by the claims.

It will be appreciated that the present disclosure is not limited to the exact structure that has been described above and illustrated in the accompanying drawings, and that various modifications and changes can be made without departing from the scope thereof. The scope of the present disclosure is only limited by the appended claims.

What is claimed is:

1. A method for displaying object information, comprising:
displaying, in response to an access operation on a target live-streaming room, a live-streaming interface of the target live-streaming room; and
displaying a first object information display component and a second object information display component in the live-streaming interface, wherein component styles of the first object information display component and the second object information display component are different, and the component style comprises at least one of a component layout style, a component display size, or a component display position;
wherein the first object information display components is configured to display description information of a recommended object, the recommended object is an object currently recommended in the target live-streaming room, the second object information display component is configured to display description information of an associated object, and the associated object is an object associated with the target live-streaming room.

2. The method for displaying object information according to claim 1, wherein the associated object is an object that has been put on shelves of the target live-streaming room.

3. The method for displaying object information according to claim 1, wherein the first object information display component is a card component, and the second object information display component is a bubble component.

4. The method for displaying object information according to claim 1, wherein the associated object comprises a plurality of associated objects, said displaying the second object information display component in the live-streaming interface comprises:
acquiring a target object list by arranging and combining the plurality of associated objects according to a preset arrangement and combination rule; and
displaying the description information of the associated objects in the target object list in the second object information display component.

5. The method for displaying object information according to claim 4, wherein the associated objects are commodities that have been put on shelves, wherein the preset arrangement and combination rule determines the target object list based on matching degrees between an audience user and the commodities, and wherein the matching degrees are acquired by processing characteristics of the audience user and characteristics of commodities through a pre-trained recommendation model.

6. The method for displaying object information according to claim 4, wherein the description information of the associated objects comprises object images, and said displaying the description information of the associated objects in the target object list in the second object information display component comprises:
cyclically displaying, in response to a quantity of objects of the plurality of associated objects in the target object list being greater than a preset quantity threshold, the object images of the plurality of associated objects by sliding the object images sequentially from one side to another side of the second object information display component.

7. The method for displaying object information according to claim 1, wherein said displaying the second object information display component in the live-streaming interface comprises:
displaying the second object information display component in a target region in the live-streaming interface;
wherein the target region is above or below a public comment display region of the live-streaming interface, and the public comment display region is configured to display comment information in the target live-streaming room.

8. The method for displaying object information according to claim 1, wherein said displaying the second object information display component in the live-streaming interface comprises:
displaying object viewing prompt information in the second object information display component, wherein the object viewing prompt information is configured to prompt at least one associated object that has been released by an anchor of the target live-streaming room, and/or a quantity of the at least one associated object.

9. The method for displaying object information according to claim 1, wherein the method further comprises:
in response to a trigger operation on the second object information display component, displaying, in the live-streaming interface, a description information display page of the associated object displayed in the second object information component, wherein the description information display page is configured to display the description information of the associated object; and
receiving an object interaction request initiated for the associated object through the description information display page.

10. The method for displaying object information according to claim 9, wherein the second object information display component includes a control configured to, upon the trigger operation, cause a display of the description information display page of the associated object in the live-streaming interface.

11. The method for displaying object information according to claim 9, wherein the second object information display component includes an image of the associated object, and the image is configured to, upon the trigger operation, cause a display of a description information display page.

12. The method for displaying object information according to claim 9, wherein the description information display page is a virtual shopping cart page of an anchor of the target live-streaming room, and the virtual shopping cart page is displayed as a half-screen on the live-streaming interface.

13. The method for displaying object information according to claim 9, wherein the description information display page is a virtual show-window page of an anchor of the target live-streaming room, and the virtual show-window page is displayed as a half-screen on the live-streaming interface.

14. An electronic device comprising:
a processor; and
a memory, configured to store one or more instructions executable by the processor;
wherein the processor, when loading and executing the one or more instructions, is caused to:
display, in response to an access operation on a target live-streaming room, a live-streaming interface of the target live-streaming room; and
display at least two object information display components in the live-streaming interface, not all component styles of different object information display components being identical, wherein at least one of the object information display components is configured to display description information of a recommended object, the recommended object being an object currently recommended in the target live-streaming room, and at least one of the object information display components is configured to display description information of an associated object, the associated object being an object associated with the target live-streaming room.

15. A non-transitory computer-readable storage medium, wherein one or more instructions in the computer-readable storage medium, when loaded and executed by a processor of an electronic device, cause the electronic device to:
display, in response to an access operation on a target live-streaming room, a live-streaming interface of the target live-streaming room; and
display at least two object information display components in the live-streaming interface, not all component styles of different object information display components being identical, wherein at least one of the object information display components is configured to display description information of a recommended object, the recommended object being an object currently recommended in the target live-streaming room, and at least one of the object information display components is configured to display description information of an associated object, the associated object being an object associated with the target live-streaming room.
